(19) United States
(12) Patent Application Publication
(10) Pub. No.: US 2005/0033576 A1
(43) Pub. Date: Feb. 10, 2005

(54) Task specific code generation for speech recognition decoding

(75) Inventors: Benoit Maison, White Plains, NY (US); Geoffrey Gerson Zweig, Ridgefield, CT (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/637,219

(22) Filed: Aug. 8, 2003

(51) Int. Cl. G10L 15/00

(52) U.S. Cl. 704/256

(57) ABSTRACT

A code generation program is provided that reads in the task-specific parameters of a speech recognition system and produces a source-language decoder program that is specialized to these parameters. The decoder program is then compiled and distributed. The process of profile-driven code optimization may be used to further enhance the output program. For ease of distribution, the system may be compiled in several parts, and assembled (linked) later, for example through the mechanism of dynamically loaded libraries.

### BACKGROUND OF THE INVENTION

1. Technical Field

The present invention relates to data processing systems and, in particular, to speech recognition. Still more particularly, the present invention provides a method, apparatus, and program for task-specific code generation for speech recognition decoding.

2. Description of Related Art

Speech recognition is the conversion of spoken words into text. Speaker-dependent systems require that users enunciate samples into the system in order to tune it to their individual voices. Speaker-independent systems do not require tuning and can recognize vocabularies and grammars for specific tasks. For example, such systems may allow users to make airline reservations or perform automated banking tasks.

Speech recognition systems frequently perform highly regular computations, but cannot take advantage of the regularity in these computations because they are written to handle more general cases than they are faced with in a specific task. For example, in a system that uses a grammar or a language model that is compiled into a fixed decoding graph, the sequence of operations that are required to advance a Viterbi search by one time-step are completely determined once the grammar is known. See Zweig and Padmanabhan, “Exact Alpha-Beta Computation in Logarithmic Space with Application to MAP Word Graph Construction,” ICSLP-2000; Zweig, Saon, and Yvon, “Arc Minimization in Finite State Decoding Graphs with Cross-Word Context,” 2002, herein incorporated by reference.

In an example, the operations that convert the raw audio signal into the vectors of features are known in advance, but the computer code may be designed to handle more general cases, for example arbitrary transformation matrices. In yet another example, the code used to evaluate Gaussians is typically written in such a way as to be able to handle any number of dimensions, but when a specific number of dimensions are known, faster code may be possible. See Aiyer, Gales and Picheny, “Rapid Likelihood Computation of Supspace Clustered Gaussian Components,” ICASSP 2000, herein incorporated by reference. Similarly, the code used to evaluate a fast-match tree can handle a tree built from any vocabulary. See M. Novak and M. Picheny, “Speed Improvement of the Time-Asynchronous Acoustic Fast Match,” Eurospeech 1999, herein incorporated by reference.

### SUMMARY OF THE INVENTION

In order to accommodate a wide variety of grammars, the systems described above are not optimized for any particular grammar. Therefore, it would be advantageous to provide, for example, improved code generation and optimization for task-specific speech recognition based on known input system data.

The exemplary aspects of the present invention provide, for example, a program that reads in the task-specific parameters of a speech recognition system and produces a source-language decoder program that is specialized to these parameters. The decoder program is then compiled and distributed. In an exemplary aspect, the process of profile-driven code optimization may be used to further enhance the output program. For ease of distribution, the system can be optionally compiled in several parts, and assembled (linked) later, for example through the mechanism of dynamically loaded libraries.

### BRIEF DESCRIPTION OF THE DRAWINGS

The exemplary aspects of the present invention will best be understood by reference to the following detailed description when read in conjunction with the accompanying drawings, wherein:

FIG. 1 is a pictorial representation of a data processing system in which the exemplary aspects of the present invention may be implemented;

FIG. 2 is a block diagram of a data processing system in which the exemplary aspects of the present invention may be implemented;

FIG. 3 illustrates an exemplary speech recognition system in accordance with an exemplary aspect of the present invention;

FIG. 4 depicts an exemplary task-specific code generation system for speech recognition in accordance with an exemplary aspect of the present invention; and

FIG. 5 is a flowchart illustrating the operation of an exemplary code generation system for task-specific speech recognition in accordance with an exemplary aspect of the present invention.

### DETAILED DESCRIPTION OF THE ILLUSTRATIVE EMBODIMENT

In the exemplary aspects of the present invention, the speed of a speech recognition system is increased, for example, by automatically generating code that is specific to a particular task. For example, code may be generated that is optimized for a particular grammar or for a particular set of Gaussians, or for a particular vocabulary. This process is related to the process of profile-based optimization. See P. P. Chang, S. A. Mahlke, and W. W. Hwu, “Using profile information to assist classic compiler code optimizations,” Software Practice and Experience, 21(12):1301-1321, 1991, herein incorporated by reference. In profile-based optimization, a program is first written and run with typical input parameters, and an execution profile is generated. This profile indicates such events as cache-misses, pipeline stalls, and memory paging. Based on the information present in the profile, the program code is re-organized so as to reduce the expected runtime when the program is recompiled and run again. The exemplary aspects of the present invention are significantly different from the process of profile-based optimization in that, for example:
1) No profile is necessary. The exemplary aspects of the present invention use, for example, optimizations that are based on a-priori knowledge of the structure of the speech recognition process. These optimizations may not be apparent or possible in the context of profile-driven optimization.
2) In the exemplary aspects of the present invention, the optimization techniques built into the compiler may generate more efficient code, for example, by making more information available to them at compile time, such as the grammar, the signal processing parameters, the dimensionality of the Gaussians, etc. When better compilers are released, a larger gain in efficiency may be expected due to this technique. Similarly, if a compiler performs platform-specific optimizations by structuring the machine code differently for different processor types or different computer architectures, then revealing more of the structure of the computations will allow the compiler to make the most out of those optimizations.

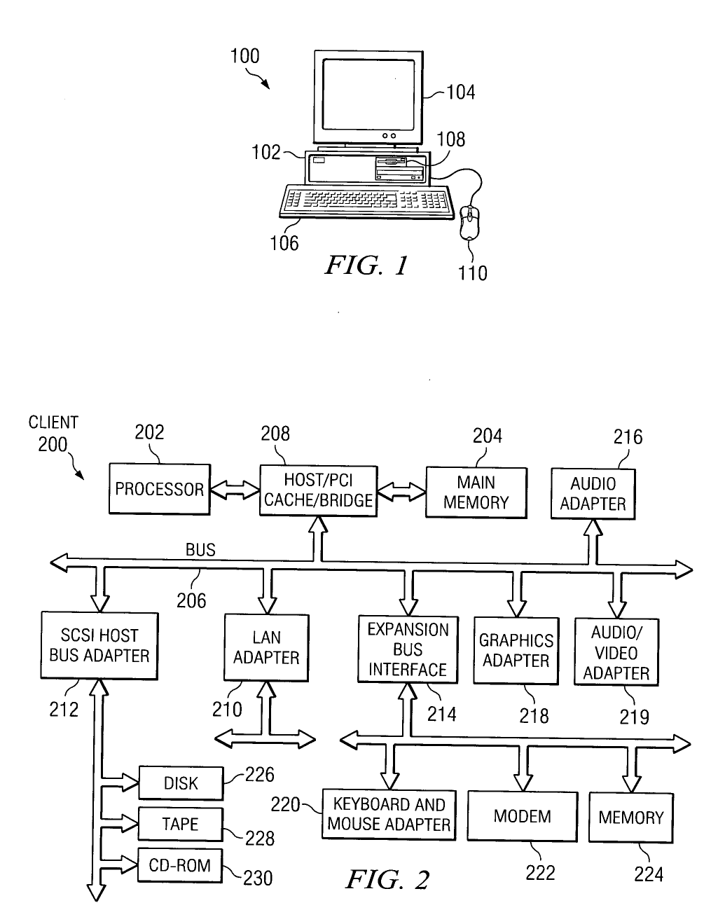

With reference now to the figures and in particular with reference to FIG. 1, a pictorial representation of a data processing system in which the exemplary aspects of the present invention may be implemented is depicted. A computer 100 is depicted which includes system unit 102, video display terminal 104, keyboard 106, storage devices 108, which may include floppy drives and other types of permanent and removable storage media, and mouse 110. It should be appreciated that the exemplary aspects of the present invention are not limited to the input devices shown in FIG. 1, and that additional input devices may be included with personal computer 100, such as, for example, a joystick, touchpad, touch screen, trackball, microphone, and the like.

Computer 100 may be implemented using any suitable computer, such as an IBM eServer computer or IntelliStation computer, which are products of International Business Machines Corporation, located in Armonk, N.Y. Although the depicted representation shows a computer, other embodiments of the various exemplary aspects of the present invention may be implemented in other types of data processing systems, such as a network computer. Computer 100 also may include a graphical user interface (GUI) that may be implemented by means of systems software residing in computer readable media in operation within computer 100.

With reference now to FIG. 2, a block diagram of a data processing system is shown in which the exemplary aspects of the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

The processes of the exemplary aspects of the present invention are performed by processor 202 using computer implemented instructions, which may be located in a memory such as, for example, main memory 204, memory 224, or in one or more peripheral devices 226-230. An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the exemplary aspects of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

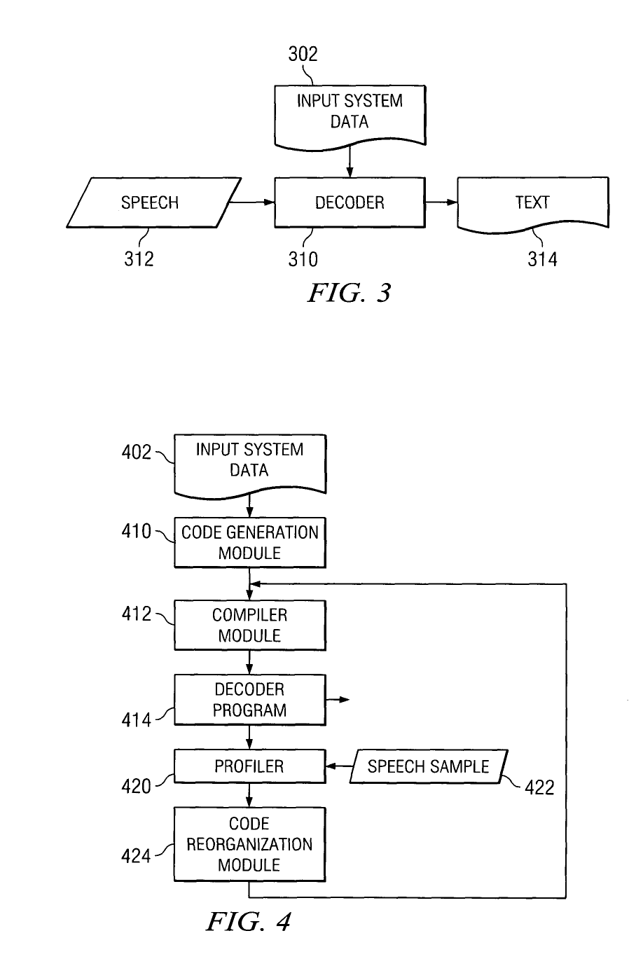

FIG. 3 illustrates an exemplary speech recognition system in accordance with an exemplary aspect of the present invention. Decoder 310 receives input system data 302 as parameters for speech recognition. Decoder 310 may perform task-specific speech recognition. For example, the speech recognition system shown in FIG. 3 may allow users to make airline reservations or perform online banking. Decoder 310 receives 312 and converts this speech into text 314.

FIG. 4 depicts an exemplary task-specific code generation system for speech recognition in accordance with an exemplary aspect of the present invention. The task-specific knowledge 402 present in a speech recognition system is gathered together. This information includes, but is not limited to, the following:
1) a language model, such as a grammar or a set of n-gram probabilities;
2) an acoustic model, such as a collection of Gaussians and state-transition probabilities;
3) a front-end, for example that computes Mel-frequency cepstral coefficients of a given dimensionality; and,
4) information related to speaker-adaptation, for example the parameters of pre-computed speaker clusters.
   The language and acoustic models may be represented as Hidden Markov Models. The system information is passed into a code-generation module 410. This module converts the system specifications into a computer language suitable for compilation, for example into the C programming language. Compiler module 410 generates decoder program 414. This module contains a template for expanding the system parameters into the programming language of choice. The module combines this generic information with system-specific information to output the final code. For ease of distribution, the system can be optionally compiled in several parts, and assembled (linked) later, before execution, for example through the mechanism of dynamically loaded libraries.

Knowledge of the exact details of a task can be used to speed computations in several ways. For example, loop checks can be removed. This eliminates pipeline stalls. For example, in an alpha-computation, the following loop may exist:

$$\begin{matrix}for i = 1 to node . num\_predecessors \\ alpha += node . predecessor [ i ] . alpha * \\ node . transition\_prob \_for \_pred [ i ] \\ can be “ unrolled ” and replaced by \text{:} \\ alpha += node . predecessor [ 1 ] . alpha * \\ node . transition\_prob \_for \_pred [ 1 ] \\ alpha += node . predecessor [ 2 ] . alpha * \\ node . transition\_prob \_for \_pred [ 2 ] \\ …\end{matrix}$$

Thus, rather than doing node.num_predecessors loop iterations with the associated overhead, a simple sequence of node.num_predecessors statements may be executed without and looping overhead.

Indirect memory references may also be eliminated. The exact location of quantities can be determined in advance. This eliminates unnecessary operations required with indirect memory accessing. Essentially, all quantities can be stored in a single array. To continue the above example, the code would be reduced to the following:

$$\begin{matrix}alpha += mem\_loc [ 1 ] * mem\_loc [ 2 ] \\ alpha += mem\_loc [ 3 ] * mem\_loc [ 4 ] \\ …\end{matrix}$$

Since structure members are no longer accessed, this representation has less indirection than the preceding code.

Quantities may also be arbitrarily rearranged in memory to reduce cache misses. To continue the preceding example, all of the memory locations may be pre-assigned. This assignment may be made so as to minimize the number of cache misses, and maximize the effectiveness of memory interleaving. This is not possible with conventional techniques, because a human programmer cannot reason in terms of arbitrary memory arrangements; a code-generating program can. Alternatively, the single array may be replaced by a large number of scalar variables. This lets the compiler, rather than the code-generating program, optimize the memory locations in order to minimize cache misses. The code from the above example would be reduced to the following:
alpha+=local_var1*local_var2
alpha+=local_var3*local_var4
The above techniques may also be combined.

The code is compiled using compiler module, such as GNU g++. Decoder program 414 represents the output speech recognition program. This optimized program is the output of this invention and is ready for use. For ease of distribution, the system may be compiled in several parts, and assembled (linked) later, for example through the mechanism of dynamically loaded libraries.

Alternatively, further optimization may be implemented through a process of profile-driven optimization. Speech data 422 that is representative of the speech that the system will encounter in normal use may be collected. The decoder program is run in profiler 420 with sample speech data 422. The results are analyzed by code re-organization module 424, which re-arranges the code and re-assigns memory locations to improve the expected performance. The output code is then feed back into compiler module 412 and this process may repeat until decoder program 414 is optimized.

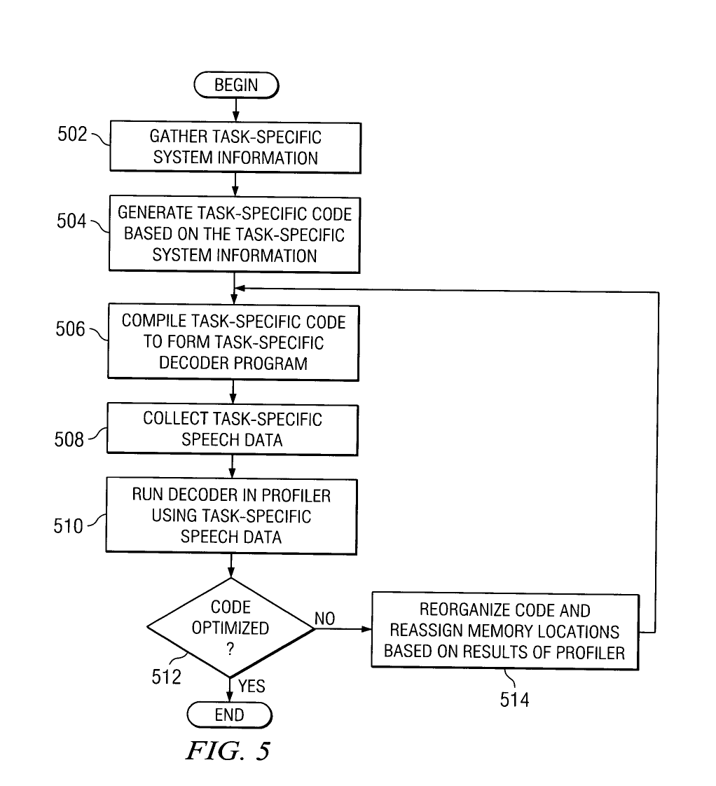

With reference now to FIG. 5, a flowchart is shown illustrating the operation of an exemplary code generation system for task-specific speech recognition in accordance with an exemplary aspect of the present invention. The process begins and gathers task-specific system information (step 502). The process then generates task-specific code based on the task-specific system information (step 504). Then, the process compiles task-specific code to form a task-specific decoder program (step 506).

Thereafter, the process may optionally collect task-specific speech data (step 508) and run the decoder program in a profiler using the task-specific speech data (step 510). A determination is made as to whether the code is optimized (step 512). If the code is optimized, the process ends. However, if the code is not optimized in step 512, the process reorganizes the code and reassigns memory locations based on the results from the profiler (step 514). Then, the process returns to step 506 to compile the task-specific code.

Thus, the exemplary aspects of the present invention at least solve the disadvantages of the prior art by, for example, providing a program that reads in the task-specific parameters of a speech recognition system and produces a source-language decoder program that is specialized to these parameters. The decoder program is then compiled and distributed. In an exemplary aspect, the process of profile-driven code optimization may be used to further enhance the output program. For ease of distribution, the system may be compiled in several parts, and assembled (linked) later, for example through the mechanism of dynamically loaded libraries. The exemplary aspects of the present invention do not require a profile. The code generation system of the exemplary aspects of the present invention also makes use of code optimization techniques available in compilers and permits platform-specific optimizations based on task-specific parameters of a speech recognition system.

It is important to note that while the various exemplary embodiments present invention have been described in the context of a fully functioning data processing system, those of ordinary skill in the art will appreciate that the processes of the various exemplary embodiments of the present invention may be distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the various exemplary embodiments the present invention has been presented for purposes of illustration and description, and is not intended to be exhaustive or limited to the invention in the form disclosed. Many modifications and variations will be apparent to those of ordinary skill in the art. The various exemplary embodiments were chosen and described in order to best explain the principles of the invention, the practical application, and to enable others of ordinary skill in the art to understand the invention for various embodiments with various modifications as are suited to the particular use contemplated.

1. A method for generating task-specific code for pattern recognition, the method comprising:
receiving task-specific input system data of a pattern recognition system; and
generating task-specific code for the pattern recognition system based on the task-specific input system data.

2. The method of claim 1, wherein the pattern recognition system performs speech recognition.

3. The method of claim 2, wherein the task-specific input system data includes one of a language model, an acoustic model, a front-end for computing feature vectors, and information related to speaker adaptation.

4. The method of claim 3, wherein the acoustic model includes Gaussians.

5. The method of claim 3, wherein the language model is represented as a Hidden Markov Model.

6. The method of claim 3, wherein the acoustic model is represented as a Hidden Markov Model.

7. The method of claim 1, further comprising:
compiling the task-specific code to form a decoder program.

8. The method of claim 7, further comprising:
profiling the decoder program to form a profile; and
determining whether the decoder program is optimized.

9. The method of claim 8, further comprising:
responsive to the decoder program not being optimized, automatically modifying and recompiling the decoder program based on the profile.

10. The method of claim 7, wherein the step of compiling the task-specific code includes compiling the task-specific code in several parts corresponding to several modules of the pattern recognition system and assembling the compiled code before execution.

11. A computer program product, in a computer readable medium, for generating task-specific code for pattern recognition, the computer program product comprising:
instructions for receiving task-specific input system data of a pattern recognition system; and
instructions for generating task-specific code for the pattern recognition system based on the task-specific input system data.

12. The computer program product of claim 11, wherein the pattern recognition system performs speech recognition.

13. The computer program product of claim 12, wherein the task-specific input system data includes one of a language model, an acoustic model, a front-end for computing feature vectors, and information related to speaker adaptation.

14. The computer program product of claim 11, further comprising:
instructions for compiling the task-specific code to form a decoder program.

15. The computer program product of claim 14, further comprising:
instructions for profiling the decoder program to form a profile; and
instructions for determining whether the decoder program is optimized.

16. The computer program product of claim 15, further comprising:
instructions, responsive to the decoder program not being optimized, for automatically modifying and recompiling the decoder program based on the profile.

17. An apparatus for generating task-specific code for pattern recognition, the method comprising:
a code generator, wherein the code generator receives task-specific input system data of a pattern recognition system and generates task-specific code for the pattern recognition system based on the task-specific input system data; and
a compiler, wherein the compiler compiles the task-specific code to form a decoder program for the pattern recognition system.

18. The apparatus of claim 17, wherein the pattern recognition system performs speech recognition.

19. The apparatus of claim 18, wherein the task-specific input system data includes one of a language model, an acoustic model, a front-end for computing feature vectors, and information related to speaker adaptation. 20. The apparatus of claim 17, further comprising:
a profile, wherein the profiler profiles the decoder program to form a profile and determines whether the decoder program is optimized.
